(19) United States
(12) Patent Application Publication
(10) Pub. No.: US 2012/0267416 A1
(43) Pub. Date: Oct. 25, 2012

(54) Safety Catch Mechanism for Nail Gun

(76) Inventors: Raymond Wong, Alhambra, CA (US); Patrick Wang, Tali City (TW)

(21) Appl. No.: 13/091,402

(22) Filed: Apr. 21, 2011

(51) Int. Cl. B25C 1/00

(52) U.S. Cl. 227/8

(57) ABSTRACT

A safety catch mechanism, comprising a safety catch that is captively attached to the barrel of a nail gun by matching tracks on both said safety catch and said barrel, facing each other, so that said safety catch is allowed to move only in the forward and backward directions along the barrel of the nail gun in the direction of the motion of the nails, is disclosed. A forward pushing means keeps the forward end of the safety catch beyond the muzzle of the nail gun in the initial secured position. As the safety catch is pushed back, the trigger of the nail gun is activated.

### FIELD OF THE INVENTION

The present invention relates to staple or nail guns, and more particularly, the safety catch of staple or nail guns.

### BACKGROUND OF THE INVENTION

Staple or nail guns have been in existence for some time. In U.S. Pat. Nos. 2,585,941 and 2,850,738, the safety design for regular guns only prevents the activation of the trigger when the safety switch is switched to safe position.

Various safety catches are proposed (e.g., U.S. Pat. Nos. 5,495,973, 6,533,156, 6,691,907 and 6,695,193) for additional safety, i.e., to prevent the nail guns from firing unless they are firmly pressed against an object. The bulkiness of the safety catch mechanism suggested by these patents at the muzzle prevents the gun from being effectively used at an angle or in tight corners, either because the safety pin would not be fully pressed back to activate the trigger, or because the structure to hold the safety catch in place or the bulky safety catches themselves create a distance between the muzzle and the surface.

### SUMMARY OF THE INVENTION

The present invention proposes a safety catch mechanism, comprising a safety catch that is captively attached to the barrel of a nail gun by a pair of matching tracks on both the safety catch and said barrel facing each other. Said tracks allows the safety catch to move only in both forward and backward directions along the barrel of the nail gun in the direction of the motion of the nails, is disclosed. A forward pushing means keeps the forward end of the safety catch beyond the muzzle of the nail gun in the initial secured position. As the safety catch is pushed back, the trigger of the nail gun is activated.

The advantage of the present invention includes that said invention allows the nail gun to be used at an angle and at small corners.

### BRIEF DESCRIPTION OF THE DRAWINGS

FIG. 1 is a perspective view of the nail gun with the preferred embodiment of the present invention.

FIG. 2 is an exploded view of the nail gun.

FIG. 3 is a cross-sectional view of the nail gun showing the nail gun with both the trigger and the safety catch in its normal condition.

FIG. 4 is a cross-sectional view of the nail gun showing the nail gun with the trigger pulled back and the safety catch in its normal condition.

FIG. 5 is a cross-sectional view of the nail gun showing the nail gun with the safety catch pressed backward and the trigger in its normal condition.

FIG. 6 is a cross-sectional view of the nail gun showing the nail gun with the safety catch pressed backward and the trigger pulled.

FIG. 7 is a perspective view of the bottom side of the barrel and the safety catch.

FIG. 8 is a cross-sectional view of the trapezoidal track between the barrel and the safety catch.

FIG. 9 is a perspective view of an alternative embodiment with tapered barrel and safety catch.

### DETAILED DESCRIPTION OF THE INVENTION

A nail gun with the preferred embodiment of the present invention is described as follows.

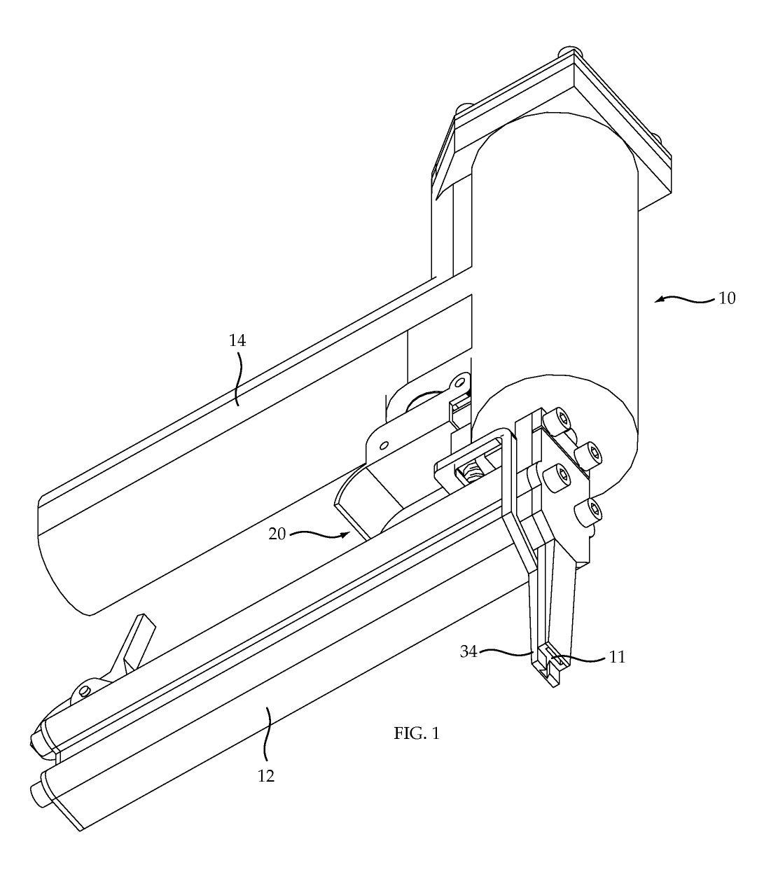

FIG. 1 shows a main body 10, a trigger set 20, a barrel 11, a safety catch 34, a magazine 12, and a handle 14, of the nail gun.

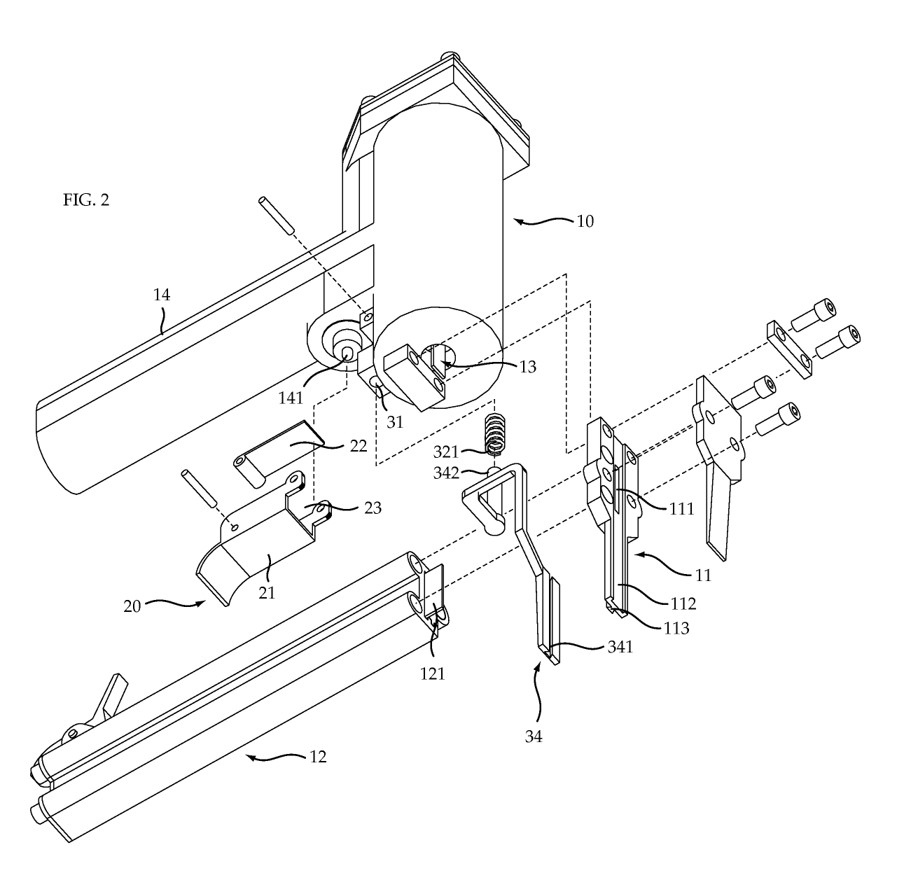

FIG. 2 shows that the main body 10 comprises the barrel 11 equipped at the front of the main body 10. The top side of barrel 11 comprises a hollow nail striking chamber 111 therein, and a nail shooting exit 112 at the tip of the barrel 11. The magazine 12 is set underneath the barrel 11, and the magazine 12 interconnects with the nail striking chamber 111 internally and a movable spring plate 121 movably provided inside the magazine 12 for pushing nails stored in the magazine 12 in sequence into the nail striking chamber 111. A firing pin 13 is extendable to project into the nail striking chamber 111 to strike a nail out of the nail shooting exit 112. The main body 10 further comprises the handle 14. The bottom side of the barrel 11 comprises, along the axial direction, a male trapezoidal track 113. The male trapezoidal track 113 is continuous along the entire length of the barrel 11 so the male trapezoidal track 113 can be designed to be small. The handle 14 is connected with the main body 10 in such a way that the handle 14 can be easily held by a user and comprises a switch 141 thereon for controlling the operation of the firing pin 13.

The trigger set 20 includes a trigger 21 that is hollow inside and comprises an upper end pivotally connected with the main body 10 in front of the switch 141. A triggering plate 22 is provided within the trigger 21 and comprises a lower end pivotally connected with a lower portion in the inside of the trigger 21. A through hole 23 is provided on the upper end of the trigger 21 for intercommunicating between the upper end of the safety catch 342 and the upper end of the triggering plate 22.

The axially movable upper end of the safety catch 342 is received within the trough 31 and extending with the upper end of the safety catch 342 facing the upper end of the triggering plate 22 and a spring 321 settled between the trough 31 and the safety catch 34 for allowing the safety catch 34 to return to its initial position; the upper end of the safety catch 342, through the through hole 23, enters into the trigger 21.

The safety catch 34 is axially movable underneath the barrel 11. Therein, the safety catch 34 comprises a trapezoidal groove 341 set axially and corresponding to the male trapezoidal track 113 for guiding the motion of the axially movable safety catch 34 and to keep the safety catch 34 captively attached to the barrel 11. The front end of the safety catch 34 extends beyond the front end of the barrel 11. When the safety catch 34 is pressed in the rear direction, the upper end of the triggering plate 22 is pressed toward the rear.

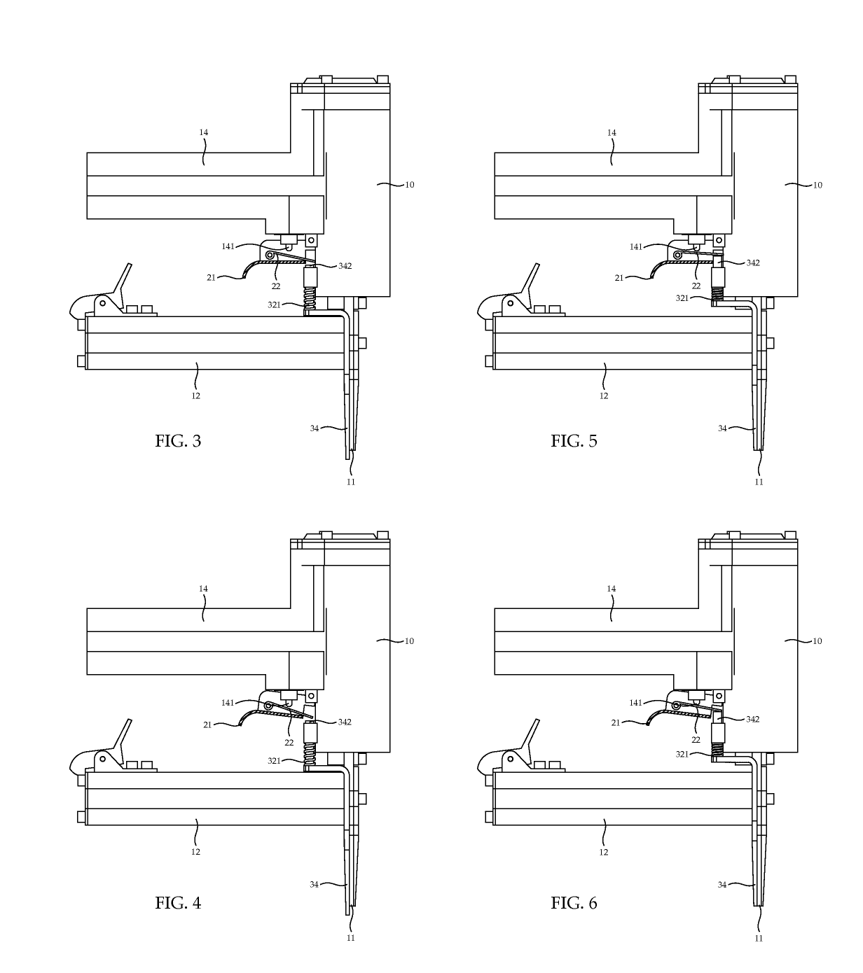

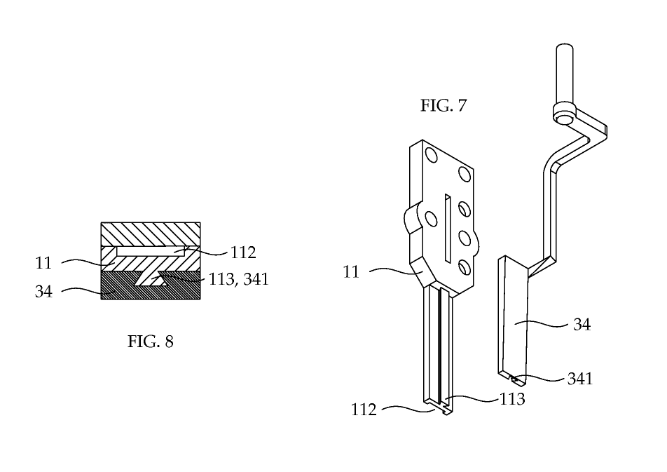

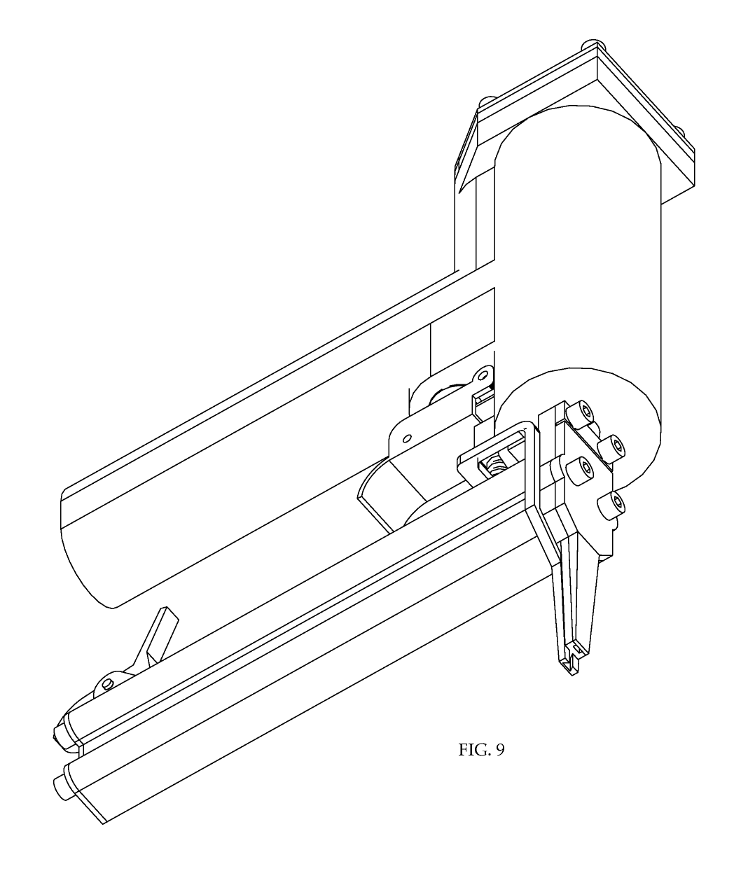

FIG. 3 shows that, when the front end of the safety catch 34 is not pressing against a targeting surface, into which a nail will be inserted, there is a space exists between the upper end of the safety catch 342 and the upper end of the triggering plate 22, so as to allow the triggering plate 22 to freely move pivotally against the trigger 21 with the pivotal point at the lower end of the triggering plate 22. Therefore, as depicted in FIG. 4, even the trigger 21 is pulled accidentally, the triggering plate 22 movably retreats inside the trigger 21, enabling the switch 141 stay inactivated so that keeping the safety of the nail gun in use.

FIG. 5 shows the front end of the safety catch 34 being pressing against the targeting surface, the safety catch 34 retreats to the barrel 11, and pushes the upper end of the safety catch 342 toward the upper end of the triggering plate 22 toward the switch 141. As shown in FIG. 6, at this time, with the upper end of the triggering plate 22 pushed toward the switch 141, when the user pulls the trigger 21, the triggering plate 22 shall pass the force from the upper end of the safety catch 342 and the trigger 21 to the switch 141 and thereby activate the switch 141.

What is claimed is:

1. A safety catch mechanism for a nail gun, comprising:
(a) a safety catch with a safety catch track on the side of the said safety catch facing the barrel of said nail gun;
(b) a barrel track on the barrel that matches and is captively attached to said safety catch track and allows said safety catch to move only in the forward and backward directions along said barrel of said nail gun; and
(c) a trigger engagement means to allow a trigger of said nail gun to engage when said safety catch is pushed back.

2. A safety catch mechanism according to claim 1, further comprising a forward pushing means to keep the forward end of the safety catch beyond the muzzle of the nail gun in the initial secured position, and when said forward pushing means is depressed and said safety catch is pushed back, the trigger of the nail gun is activated.

3. A safety catch mechanism according to claim 2, wherein the forward pushing means is a spring.

4. A safety catch mechanism according to claim 1, wherein said barrel track is continuous.

5. A safety catch mechanism according to claim 1, wherein said safety catch track is continuous.

6. A safety catch mechanism according to claim 1, wherein both said barrel track and said safety catch track are continuous.

7. A safety catch mechanism according to claim 6, wherein said barrel track is male and said safety catch track is female.

8. A safety catch mechanism according to claim 7, wherein the cross section of said barrel track is trapezoidal in shape so that the safety catch is captively attached to the barrel.

9. A nail gun, comprising:
(a) a main body, comprising:
i. a barrel;
ii. a magazine set underneath the barrel; and
iii. a handle connected with the main body and comprising a switch thereon;
(b) a drive set, comprising:
i. a safety catch mechanism, comprising
1. a safety catch with a safety catch track on the side of the said safety catch facing the barrel of said nail gun;
2. a barrel track on the barrel that matches and is captively attached to said safety catch track and allows said safety catch to move only in the forward and backward directions along said barrel of said nail gun; and
3. a trigger engagement means to allow a trigger of said nail gun to engage when said safety catch is pushed back; and
ii. a forward pushing means to keep the forward end of the safety catch beyond the muzzle of the nail gun in the initial secured position, and when said forward pushing means is depressed and said safety catch is pushed back, the trigger of the nail gun is activated; and
(c) a trigger set, comprising:
i. a trigger pivotally set in front of said switch; and
ii. a triggering plate coupled inside the trigger and with the lower end of said triggering plate pivotally connected with the trigger and the upper end of said triggering plate receiving said a safety catch mechanism.

10. A nail gun of claim 9, wherein the forward pushing means is a spring.

11. A nail gun of claim 9, wherein said barrel track is continuous.

12. A nail gun of claim 9, wherein said safety catch track is continuous.

13. A nail gun of claim 9, wherein both said barrel track and said safety catch track are continuous.

14. A nail gun of claim 13, wherein said barrel track is male and said safety catch track is female.

15. A nail gun of claim 14, wherein the cross section of said barrel track is trapezoidal in shape so that the safety catch is captively attached to the barrel.

16. A nail gun of claim 15, wherein both the barrel and the safety catch are tapered toward the front end of the barrel.

17. A nail gun of claim 14, wherein both the barrel and the safety catch are tapered toward the front end of the barrel.

18. A nail gun of claim 13, wherein both the barrel and the safety catch are tapered toward the front end of the barrel.

19. A nail gun of claim 10, wherein both the barrel and the safety catch are tapered toward the front end of the barrel.

20. A nail gun of claim 9, wherein both the barrel and the safety catch are tapered toward the front end of the barrel.
